(19) United States
(12) Patent Application Publication
(10) Pub. No.: US 2024/0154562 A1
(43) Pub. Date: May 9, 2024

(54) MOTOR DRIVE DEVICE

(71) Applicant: HITACHI ASTEMO, LTD., Hitachinaka-shi, Ibaraki (JP)

(72) Inventors: Yukio HATTORI, Hitachinaka-shi, lbaraki (JP); Hirohito IMAI, Hitachinaka-shi, lbaraki (JP)

(73) Assignee: HITACHI ASTEMO, LTD., Hitachinaka-shi, Ibaraki (JP)

(21) Appl. No.: 18/549,462

(22) PCT Filed: Dec. 27, 2021
(86) PCT No.: PCT/JP2021/048502

§ 371 Date: Sep. 7, 2023

(30) Foreign Application Priority Data
Mar. 12, 2021 (JP) 2021-040427

(51) Int. Cl. H02P 27/08; H02P 25/22

(52) U.S. Cl. CPC H02P 27/08; H02P 25/22

(57) ABSTRACT

A motor drive device which drives a motor including a winding set and a winding set that are electrically separate from each other includes an inverter that outputs three-phase alternating currents to winding set, an inverter that outputs three-phase alternating currents to winding set, and controllers that output drive commands to inverter and inverter by generating PWM pulses. Controllers generate the PWM pulses such that the three-phase alternating currents that are output from inverter to winding set and the three-phase alternating currents that are output from inverter to winding set have reverse polarities in three respective phases.

### TECHNICAL FIELD

The present invention relates to a motor drive device.

### BACKGROUND ART

For example, Patent Document 1 discloses a motor drive device connected to a motor that is redundantly provided with two energization systems. This motor has two electrically separate winding sets, each of which is connected to an inverter for supplying an alternating current to its corresponding winding set.

### REFERENCE DOCUMENT LIST

### Patent Document

Patent Document 1: JP 2013-215040 A

### SUMMARY OF THE INVENTION

### Problem to be Solved by the Invention

When a half-bridge circuit constituting an inverter performs a switching operation in an individual system, the output voltage rapidly changes. It is known that a common mode current is consequently generated in the parasitic capacitance between the inverter and its housing, and between a motor and its housing. After leaking from the housings to a reference ground such as a vehicle body, this common mode current returns to power supply lines extending from the positive electrode and the negative electrode of a power supply in the same phase. The common mode current may significantly affect the operations of peripheral electric components as radiation noise. One way to reduce the common mode current is to install an electric component for noise suppression such as a Y capacitor or a choke coil in the individual system.

There is, however, an increasing demand for a smaller motor drive device, depending on its application such as an electric power steering system. If it is necessary for two systems to have electric components for noise suppression, the size reduction may not be sufficient.

The present invention has been made in view of the above problem, and it is an object of the present invention to provide a motor drive device that can reduce electric components for noise suppression while maintaining the anti-noise performance.

### Means for Solving the Problem

A motor drive device according to the present invention drives a motor including a first winding set and a second winding set that are electrically separate from each other. The motor drive device includes: a first inverter that outputs three-phase alternating currents to the first winding set; a second inverter that outputs three-phase alternating currents to the second winding set; and a controller that outputs drive commands to the first inverter and the second inverter by generating PWM pulses. The controller generates the PWM pulses such that the three-phase alternating currents that are output from the first inverter to the first winding set and the three-phase alternating currents that are output from the second inverter to the second winding set have reverse polarities in three respective phases.

### Effects of the Invention

The motor drive device according to the present invention can reduce electric components for noise suppression while maintaining the anti-noise performance.

### BRIEF DESCRIPTION OF THE DRAWINGS

FIG. 1 schematically illustrates an example of the configuration of an electric power steering system.

FIG. 2 is an axial sectional view schematically illustrating a structural example of a motor.

FIG. 3 is a section view taken along a line X in FIG. 2, schematically illustrating arrangement of winding sets of the motor.

FIG. 4 schematically illustrates an example of a circuit configuration of the electric power steering system.

FIG. 5 schematically illustrates an example of the configuration of a controller.

FIG. 6 is a block diagram illustrating an example of functions of the controller.

FIG. 7A and FIG. 7B schematically illustrate an example of three-phase voltage command values and carrier signals in first and second systems.

FIGS. 8A to 8F schematically illustrate an example of PWM pulses and common mode currents in the first and second systems.

FIG. 9 schematically illustrates an example of three-phase currents of the motor.

FIG. 10 is an axial section view schematically illustrating the first variation of the motor in FIG. 2.

FIG. 11A and FIG. 11B are section views taken along a line Y and a line Z in FIG. 10, respectively, schematically illustrating arrangement of winding sets of a motor in FIG. 10.

FIG. 12 is an axial section view schematically illustrating the second variation of the motor in FIG. 2.

FIG. 13 is a section view taken along the line X in FIG. 2, schematically illustrating the third variation of the motor in FIG. 2.

FIGS. 14A to 14F schematically illustrate an example of PWM pulses and common mode currents in conventional first and second systems.

### MODE FOR CARRYING OUT THE INVENTION

Hereinafter, an example of the present invention will be described with reference to the accompanying drawings.

### Outline of Electric Power Steering System

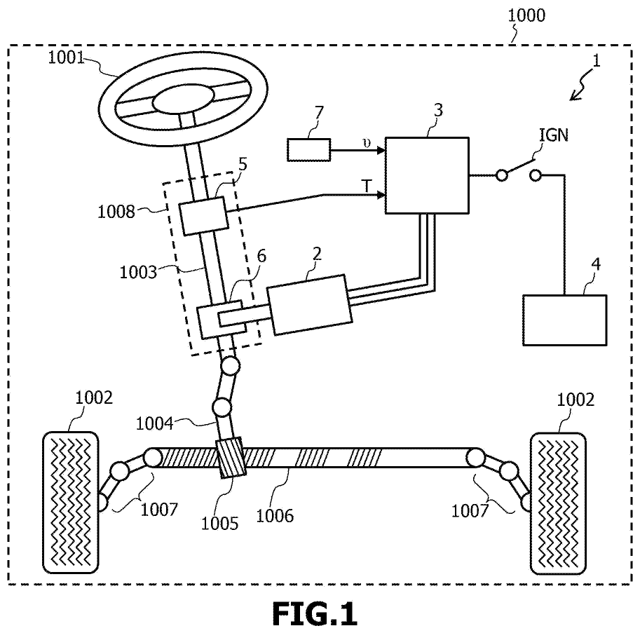

FIG. 1 illustrates an example of an electric power steering system to which a motor drive device is applied. When a driver performs a steering operation of a steering wheel 1001, a steering torque is generated to steer a controlled wheel pair 1002. An electric power steering system 1 functions as a power steering system for assisting the steering torque.

The steering torque generated by the steering operation of the steering wheel 1001 is transferred to a pinion gear 1005 connected to a pinion shaft 1004 via a steering shaft 1003, etc. The motion of pinion gear 1005 rotated by the transferred steering torque is converted into a linear motion in a vehicle width direction by a rack gear 1006 engaging with pinion gear 1005. The linear motion moves a steering mechanism pair 1007 connected to rack gear 1006. As a result, controlled wheel pair 1002 connected to their respective steering mechanisms 1007 are steered.

Electric power steering system 1 is configured such that an assist torque for assisting the steering torque is added to the steering torque transfer path to steering mechanism pair 1007. In the example illustrated in FIG. 1, electric power steering system 1 includes a motor 2 and a motor drive device 3 including a computer. Motor drive device 3 drives motor 2 such that a desired assist torque is generated. When an ignition switch IGN is turned on, power is supplied from an in-vehicle battery 4 to motor drive device 3, and as a result, electric power steering system 1 is activated.

In addition, electric power steering system 1 includes a torque sensor 5 and a decelerator 6 inside a steering column 1008 that supports steering shaft 1003. Torque sensor 5 is a torque measuring device that measures a steering torque T by any one of various detection methods such as a magnetostrictive method, a strain-gauge method, and a piezoelectric method, and that outputs a measurement signal based on steering torque T. Decelerator 6 is a velocity reduction mechanism that increases a shaft torque of motor 2 in inverse proportion to the rotation velocity, and that transfers the increased shaft torque to steering shaft 1003.

Electric power steering system 1 also includes a vehicle velocity sensor 7 as a vehicle velocity measuring device that measures a vehicle velocity ν and that outputs a measurement signal based on vehicle velocity ν. A wheel velocity sensor used in another control system, such as an anti-lock braking system (ABS) and a skid prevention device, may be used as vehicle velocity sensor 7.

Motor drive device 3 receives the measurement signals that are output from torque sensor 5, vehicle velocity sensor 7, etc., and calculates a target value (a target torque) of the assist torque based on steering torque T, vehicle velocity ν, etc., obtained from these various kinds of measurement signals. Next, motor drive device 3 performs an energization control operation on motor 2 such that the shaft torque generated by motor 2 will be closer to the calculated target torque. When the shaft torque of motor 2 generated by this energization control operation is transferred to steering shaft 1003 via decelerator 6, the steering torque is assisted by the assist torque based on the operation state of a vehicle 1000.

Although not illustrated, motor drive device 3 is also applicable to electric power steering system 1 functioning as an autonomous steering device that autonomously performs steering for autonomous driving or semi-autonomous driving of vehicle 1000. For example, an autonomous driving controller, which is mounted separately from motor drive device 3, calculates a target steering angle of steering wheel 1001 based on external environment information or the like acquired by external environment recognition means such as a camera, and outputs the calculated target steering angle to motor drive device 3. Motor drive device 3 performs the energization control operation on motor 2 such that the current steering angle detected by a steering angle sensor will be closer to the target steering angle calculated by the autonomously driving controller. By transmitting the shaft torque of motor 2 generated by this energization control operation to steering shaft 1003 via decelerator 6, vehicle 1000 can be autonomously driven.

### Redundant Configuration of Electric Power Steering System

Redundancy is achieved in electric power steering system 1, so as to improve its reliability. Specifically, motor 2 has two electrically separate winding sets as stator coils, and motor drive device 3 has two energization systems that energize their respective winding sets by using in-vehicle battery 4. In a first system, the energization control operation is autonomously performed on one of the winding sets of motor 2, and in a second system, the energization control operation is autonomously performed on the other winding set of motor 2. Motor 2 generates the target torque based on the energization control operations in these two redundant systems. In this way, even when an abnormality occurs in one system, the other normal system can continue its energization control operation on motor 2. That is, electric power steering system 1 can continuously function. Hereinafter, regarding motor 2 and motor drive device 3, “A” is included in the reference numerals of components in the first system, and “B” is included in the reference numerals of components in the second system. Components or parameters of which the reference numerals are the same except for “A” and “B” have the same meanings.

### Specific Configuration of Motor

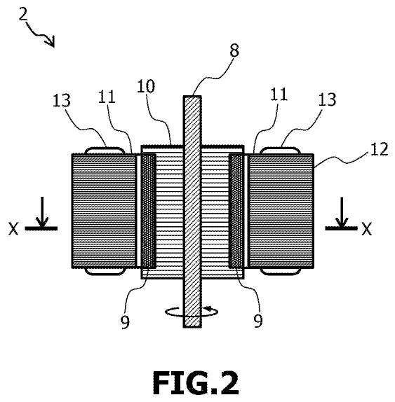

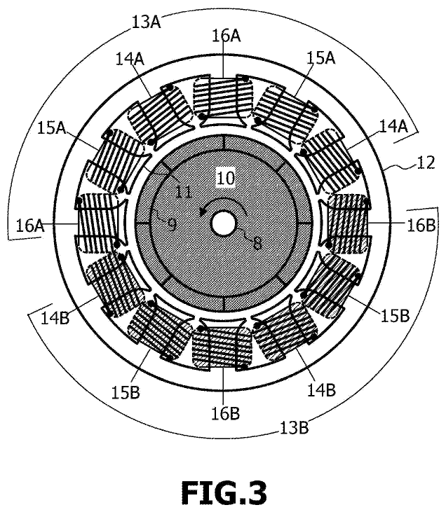

A specific configuration of motor 2 will be described with reference to FIGS. 2 and 3. FIG. 2 schematically illustrates a structure of motor 2, and FIG. 3 illustrates arrangement of the winding sets of motor 2.

Motor 2 is a three-phase brushless motor and includes a rotating shaft 8 that is rotatably supported and a rotor 10 that rotates together with rotating shaft 8. Permanent magnets 9 are arranged on rotor 10 so that their polarities are alternatively changed in the direction of rotation of rotor 10. In addition, motor 2 includes a stator 12 disposed around the outer periphery of rotor 10. Stator 12 includes a plurality of teeth 11 joined to the inner periphery of an annular yoke. Teeth 11 face permanent magnets 9 of rotor 10 via a gap in the radial direction of rotating shaft 8.

As described above, two electrically separate winding sets 13 are disposed on stator 12 of motor 2. A winding set 13A, which is one of winding set 13, is the target of the energization control operation in the first system, and is a three-phase winding set in which a U-phase coil 14A, a V-phase coil 15A, and a W-phase coil 16A are Y-connected. A winding set 13B, which is the other of winding set 13, is the target of the energization control operation in the second system, and is a three-phase winding set in which a U-phase coil 14B, a V-phase coil 15B, and a W-phase coil 16B are Y-connected. In stator 12, three-phase coils 14A, 15A, and 16A of winding set 13A are wound around half of a plurality of teeth 11 by salient-pole concentrated winding, and three-phase coils 14B, 15B, and 16B of winding set 13B are wound around the other half of a plurality of teeth 11 by salient-pole concentrated winding. In winding set 13A, U-phase coil 14A, V-phase coil 15A, and W-phase coil 16A are sequentially wound in this order around three consecutive teeth 11 in the rotation direction of rotor 10. In winding set 13B, U-phase coil 14B, V-phase coil 15B, and W-phase coil 16B are sequentially wound in this order around three consecutive teeth 11 in the rotation direction of rotor 10. However, the winding direction of three-phase coils 14A, 15A, and 16A of winding set 13A is different from that of three-phase coils 14B, 15B, and 16B of winding set 13B.

In FIG. 3, twelve teeth 11 are formed on stator 12. Winding set 13A is disposed on six consecutive teeth 11 in the rotation direction of rotor 10, and winding set 13B is disposed on remaining six teeth 11. That is, three teeth 11 around which three-phase coils 14A, 15A, and 16A of winding set 13A are wound form a first teeth set, and two first teeth sets are adjacent to each other. In addition, three teeth 11 around which three-phase coils 14B, 15B, and 16B of winding set 13B are wound form a second teeth set, and two second teeth sets are adjacent to each other. Alternatively, although not illustrated, the first teeth sets and the second teeth sets may be alternately disposed in the rotation direction of rotor 10. In short, as long as the number of teeth 11 is a multiple of 6 and the number of the first teeth sets is equal to the number of the second teeth sets, the first teeth sets and the second teeth sets may be disposed in any order in the rotation direction of rotor 10.

### Circuit Configuration of Electric Power Steering System

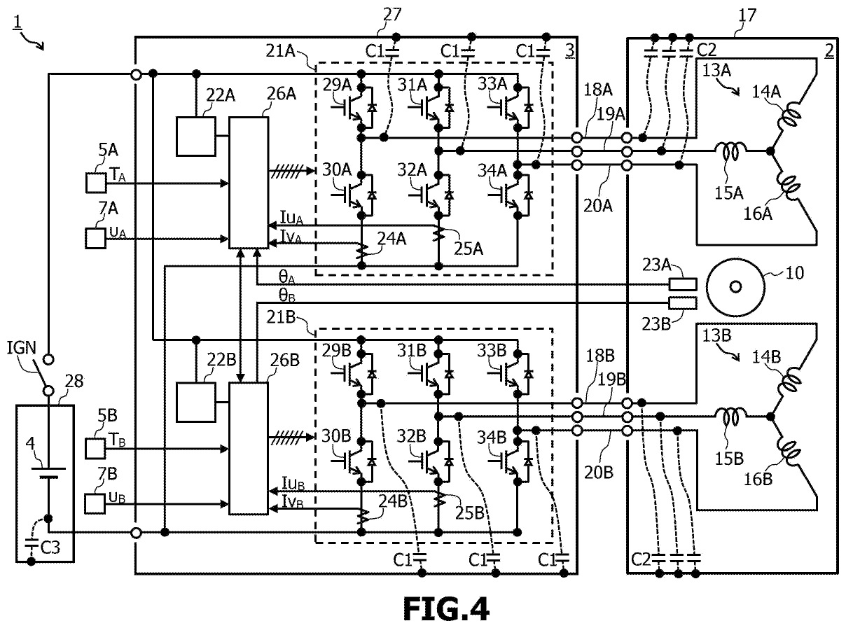

FIG. 4 illustrates a circuit configuration of electric power steering system 1.

Motor 2 is stored in a housing 17, which is electrically connected to a reference ground such as a vehicle body. Power supply lines 18A, 19A, and 20A are connected to winding set 13A of motor 2, that is, to U-phase coil 14A, V-phase coil 15A, and W-phase coil 16A, respectively. Similarly, power supply lines 18B, 19B, and 20B are connected to winding set 13B of motor 2, that is, to U-phase coil 14B, V-phase coil 15B, and W-phase coil 16B, respectively.

In the first system, motor drive device 3 includes an inverter 21A, a power supply circuit 22A, various kinds of measuring devices such as a rotation angle sensor 23A and current sensors 24A and 25A, and a controller 26A. Similarly, in the second system, motor drive device 3 includes an inverter 21B, a power supply circuit 22B, various measuring devices such as a rotation angle sensor 23B and current sensors 24B and 25B, and a controller 26B. Motor drive device 3 is stored in a housing 27, which is electrically connected to a reference ground such as the vehicle body. In electric power steering system 1, torque sensor 5 and vehicle velocity sensor 7 are also redundantly provided. That is, electric power steering system 1 includes a torque sensor 5A and a vehicle velocity sensor 7A in the first system, and includes a torque sensor 5B and a vehicle velocity sensor 7B in the second system.

When ignition switch IGN is turned on, electric power is supplied to inverter 21A from in-vehicle battery 4 stored in a housing 28. Housing 28 is electrically connected to a reference ground such as the vehicle body. Inverter 21A includes a three-phase bridge circuit in which U-phase, V-phase, and W-phase half bridge circuits are connected in parallel between a positive-electrode-side bus connected to the positive electrode of in-vehicle battery 4 and a negative-electrode-side bus connected to the negative electrode of in-vehicle battery 4. The U-phase half bridge circuit is formed by an upper-arm switching element 29A and a lower-arm switching element 30A, which are connected to each other in series. Power supply line 18A is connected to a line connecting two switching elements 29A and 30A. The V-phase half bridge circuit is formed by an upper-arm switching element 31A and a lower-arm switching element 32A, which are connected to each other in series. Power supply line 19A is connected to a line connecting two switching elements 31A and 32A. The W-phase half bridge circuit is formed by an upper-arm switching element 33A and a lower-arm switching element 34A, which are connected to each other in series. Power supply line 20A is connected to a line connecting two switching elements 33A and 34A.

In inverter 21A, each of switching elements 29A to 34A includes an anti-parallel freewheeling diode and an externally controllable control electrode, and performs a switching operation for switching between its ON and OFF states in accordance with a control signal that is input to the control electrode. For example, metal-oxide-semiconductor field-effect transistors (MOSFETs), insulated gate bipolar transistors (IGBTs), etc., can be used as switching elements 29A to 34A. In the example in FIG. 4, N-channel MOSFETs are used as switching elements 29A to 34A. When any one of switching elements 29A to 34A is turned on based on a high-level control signal (a gate signal), which is equal to or greater than a predetermined threshold voltage, the drain and the source of this switching element are electrically connected to each other. In contrast, when any one of switching elements 29A to 34A is turned off based on a low-level control signal (a gate signal), which is less than the predetermined threshold voltage, the drain and the source of this switching element are electrically disconnected from each other.

When ignition switch IGN is turned on, power supply circuit 22A adjusts the output voltage of in-vehicle battery 4 and supplies an operating voltage to controller 26A. Although not illustrated, power supply circuit 22A can appropriately supply a power supply voltage to the measuring devices that belong to the first system, such as torque sensor 5A, vehicle velocity sensor 7A, rotation angle sensor 23A, and current sensors 24A and 25A by adjusting the output voltage of in-vehicle battery 4.

Rotation angle sensor 23A is a rotation angle measuring device that measures a rotation angle θ_{A} of rotor 10 (hereinafter, referred to as “rotor rotation angle”), and that outputs a measurement signal based on measured rotor rotation angle θ_{A}. Rotation angle sensor 23A can measure rotor rotation angle θ_{A} based on various principles, using a Hall device, a resolver, a rotary encoder, etc.

Current sensors 24A and 25A are phase current measuring devices that are connected to two different phases of switching elements among the switching elements in the U-phase to W-phase half bridge circuits of inverter 21A. Alternatively, current sensors 24A and 25A may be connected to two different phases of power supply lines among power supply lines 18A to 20A. Each of current sensors 24A and 25A measures a value of a phase current actually flowing through its corresponding phase of component, and outputs a measurement signal based on the corresponding measured value. In the example illustrated in FIG. 4, current sensor 24A is connected to lower-arm switching element 30A in the U-phase half bridge circuit and outputs a measurement signal based on a value Iu_{A} of a phase current actually flowing through the U-phase half bridge circuit (hereinafter, referred to as “U-phase actual current value”). Current sensor 25A is connected to lower-arm switching element 32A in the V-phase half bridge circuit and outputs a measurement signal based on a value Iv_{A} of a phase current actually flowing through the V-phase half bridge circuit (hereinafter, referred to as “V-phase actual current value”). Current sensors 24A and 25A can measure actual current values Iu_{A} and Iv_{A} based on various measurement principles, for example, by amplifying the potential difference between both ends of a shunt resistor with an operational amplifier and outputting the amplified potential difference. A phase current measuring device that measures three-phase current values from an inverter bus current measured by a single shunt resistor (see Japanese Laid-open Patent Publication No. 2019-071755 A) may be used as the phase current measuring device. Alternatively, the phase current values may be measured by connecting a current sensor for each of the three phases.

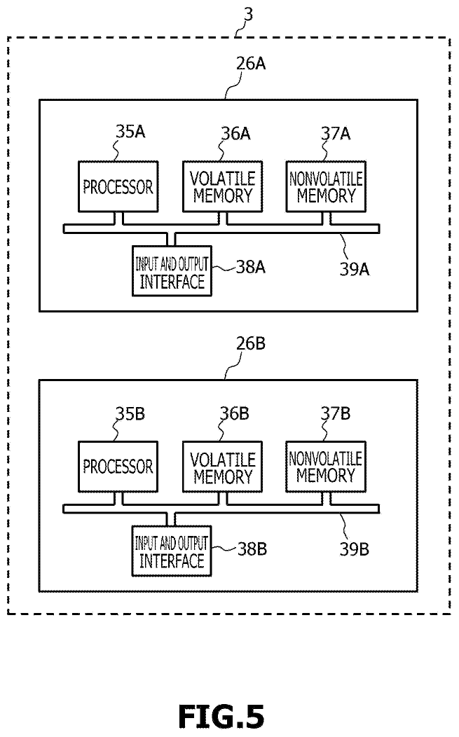

FIG. 5 schematically illustrates an example of the configuration of controller 26A. Controller 26A includes a processor 35A such as a central processing unit (CPU), a volatile memory 36A such as a random access memory (RAM), a nonvolatile memory 37A such as a read-only memory (ROM), and an input and output interface 38A. Processor 35A, volatile memory 36A, nonvolatile memory 37A, input and output interface 38A, etc., of controller 26A are connected to each other via an internal bus 39A such that these components can communicate with each other.

Controller 26A receives measurement signals that are output from torque sensor 5A, vehicle velocity sensor 7A, rotation angle sensor 23A, and current sensors 24A and 25A via input and output interface 38A. Next, processor 35A reads out a program stored in nonvolatile memory 37A and expands and executes the program in volatile memory 36A, whereby controller 26A generates drive commands (control signals) for switching elements 29A to 34A based on the above measurement signals. Controller 26A then outputs the drive commands from input and output interface 38A to switching elements 29A to 34A via a pre-driver (not illustrated) or the like and performs the energization control operation on motor 2 in the first system.

The above description of the components and parameters in the first system of motor drive device 3 is applicable to the second system of motor drive device 3 illustrated in FIGS. 4 and 5, by replacing “A” in the reference numerals with “B”. Therefore, to avoid redundant description, detailed description of the second system of motor drive device 3 in FIGS. 4 and 5 will be omitted.

### Functions of Controllers

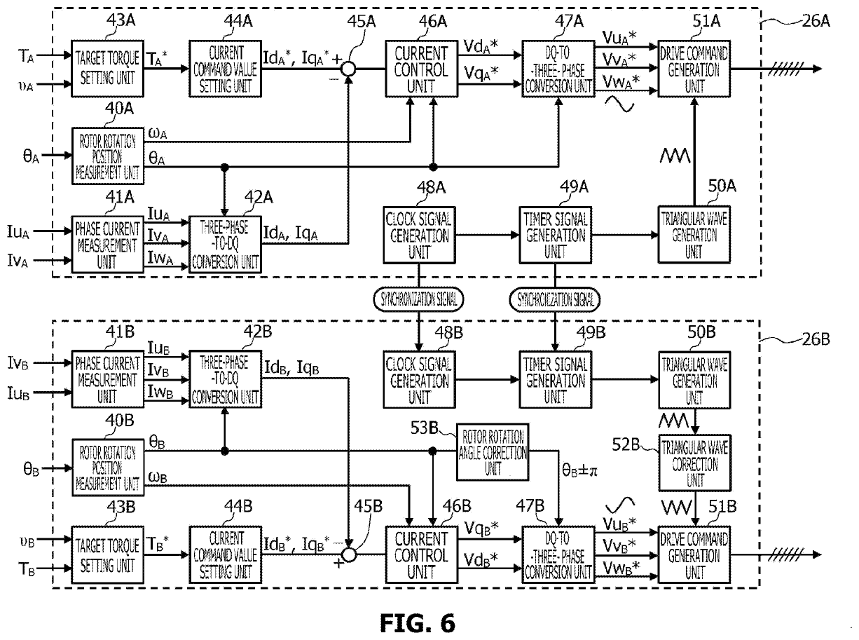

FIG. 6 illustrates functional configurations of controller 26A and controller 26B. Controller 26A includes, as schematic functional blocks, a rotor rotation position measurement unit 40A, a phase current measurement unit 41A, a three-phase-to-dq conversion unit 42A, a target torque setting unit 43A, a current command value setting unit 44A, a subtraction unit 45A, a current control unit 46A, a dq-to-three-phase conversion unit 47A, a clock signal generation unit 48A, a timer signal generation unit 49A, a triangular wave generation unit 50A, and a drive command generation unit 51A.

Rotor rotation position measurement unit 40A acquires data of rotor rotation angle θ_{A} (in electric angle) based on the measurement signal that is output from rotation angle sensor 23A. For example, rotor rotation position measurement unit 40A acquires the data of rotor rotation angle θ_{A} by performing analog/digital (A/D) conversion on an individual sampling value of the measurement signal by using an A/D converter. In addition, based on the data of rotor rotation angle θ_{A}, rotor rotation position measurement unit 40A calculates a rotor angle velocity ω_{A} corresponding to a time differential value of rotor rotation angle θ_{A} and acquires data of rotor rotation velocity ω_{A}.

Phase current measurement unit 41A acquires data of U-phase actual current value Iu_{A} based on the measurement signal that is output from current sensor 24A. Similarly, phase current measurement unit 41A acquires data of V-phase actual current value Iv_{A} based on the measurement signal that is output from current sensor 25A. For example, phase current measurement unit 41A acquires data of U-phase actual current value Iu_{A} and V-phase actual current value Iv_{A} by performing A/D conversion on sampling values of their respective measurement signals by using an A/D converter. Since the sum of the phase currents is zero, by using the acquired data of U-phase actual current value Iu_{A} and V-phase actual current value Iv_{A}, phase current measurement unit 41A calculates a value Iw_{A} of a phase current actually flowing through the W-phase half bridge circuit (hereinafter, referred to as “W-phase actual current value”) (Iw_{A}=−Iu_{A}−Iv_{A}) and acquires data of W-phase actual current value Iw_{A}.

Three-phase-to-dq conversion unit 42A converts the data of U-phase actual current value Iu_{A}, V-phase actual current value Iv_{A}, and W-phase actual current value Iw_{A} into a d-axis actual current value Id_{A} and a q-axis actual current value Iq_{A} in a two-axis rotating coordinate system (a dq coordinate system) by using the data of rotor rotation angle θ_{A} such that a vector control operation can be performed.

Target torque setting unit 43A acquires data of a steering torque T_{A} and a vehicle velocity ν_{A} based on the measurement signals that are output from torque sensor 5A and vehicle velocity sensor 7A by using an A/D converter or the like, as needed. Next, target torque setting unit 43A sets a target torque T_{A}* based on the acquired data of steering torque T_{A} and vehicle velocity ν_{A}, etc.

Current command value setting unit 44A sets current command values based on target torque T_{A}*, etc., set by target torque setting unit 43A. Specifically, current command value setting unit 44A sets a d-axis current command value Id_{A}* and a q-axis current command value Iq_{A}* in the dq coordinate system as the current command values such that a vector control operation can be performed. More specifically, d-axis current command value Id_{A}* and q-axis current command value Iq_{A}* are set such that a shaft torque based on a predetermined output ratio (for example, 50%) of inverter 21A with respect to the total output of inverters 21A and 21B is generated, of all target torque T_{A}*.

Subtraction unit 45A calculates a difference ΔId_{A} between d-axis current command value Id_{A}* and d-axis actual current value Id_{A} and a difference ΔIq_{A} between q-axis current command value Iq_{A}* and q-axis actual current value Iq_{A}.

Current control unit 46A calculates a d-axis voltage command value Vd_{A}* and a q-axis voltage command value Vq_{A}* based on rotor angle θ_{A}, rotor angle velocity ω_{A}, difference ΔId_{A}, and difference ΔIq_{A}. Specifically, current control unit 46A performs a current feedback control operation using PI control or the like in view of rotor angle velocity ω_{A} as non-interference control and calculates a d-axis voltage command value Vd_{A}* and a q-axis voltage command value Vq_{A}* such that d-axis actual current value Id_{A} will be closer to d-axis current command value Id_{A}* and such that q-axis actual current value Iq_{A} will be closer to q-axis current command value Iq_{A}*.

By using the data of rotor rotation angle θ_{A}, dq-to-three-phase conversion unit 47A converts d-axis voltage command value Vd_{A}* and q-axis voltage command value Vq_{A}* into three-phase voltage command values, that is, a U-phase voltage command value Vu_{A}*, a V-phase voltage command value Vv_{A}*, and a W-phase voltage command value Vw_{A}*, as expressed by Equations 1 below. Three-phase voltage command values Vu_{A}*, Vv_{A}*, and Vw_{A}* change sinusoidally as rotor rotation angle θ_{A} changes over time, and are obtained as alternating-current voltages having the same amplitude and having a phase difference of 120° from each other. Three-phase voltage command values Vu_{A}*, Vv_{A}*, and Vw_{A}* change at a frequency (ω_{A}/2π) proportional to rotor angle velocity ω_{A} on the time axis. The frequency of a triangular wave (i.e., the switching frequency) is set in advance to a value that is higher than the frequency of three-phase voltage command values Vu_{A}*, Vv_{A}*, and Vw_{A}*.

$$\begin{matrix}{Vu}_{A}^{*} = k ( {Vd}_{A}^{*} cos {θ}_{A} - {Vq}_{A}^{*} sin {θ}_{A} ) \\ {Vv}_{A}^{*} = k \{ {Vd}_{A}^{*} cos ( {θ}_{A} - 2 π / 3 ) - {Vq}_{A}^{*} sin ( {θ}_{A} - 2 π / 3 ) \} \\ {Vw}_{A}^{*} = k \{ {Vd}_{A}^{*} cos ( {θ}_{A} - 4 π / 3 ) - {Vq}_{A}^{*} sin ( {θ}_{A} - 4 π / 3 ) ) \\ where k is a constant\end{matrix} . \} \qquad ( 1 )$$

Clock signal generation unit 48A receives an alternating-current signal of a fundamental frequency, which is output from an oscillation circuit (not illustrated) that is disposed outside controller 26A. The oscillation circuit is provided individually for each of the first and second systems or provided commonly for both of the systems. Clock signal generation unit 48A multiplies or divides the alternating-current signal so as to generate a clock signal having a predetermined frequency.

Timer signal generation unit 49A generates, as a timer signal, a count value by counting up or counting down the number of pulses of the clock signal. Specifically, timer signal generation unit 49A starts its down-counting when the count value reaches a predetermined upper limit value and starts its up-counting when the count value reaches a predetermined lower limit value. Timer signal generation unit 49A repeats the up-counting and down-counting. The upper limit value and the lower limit value are set in advance such that the reciprocal of the time between the up-counting start timings matches the switching frequency of switching elements 29A to 34A.

Triangular wave generation unit 50A generates a triangular wave as a carrier signal having a predetermined voltage amplitude based on the timer signal. The triangular wave reaches a minimum voltage value when the timer signal indicates the lower limit value of the count value and reaches a maximum voltage value when the timer signal indicates the upper limit value of the count value.

Drive command generation unit 51A generates pulse width modulation (PWM) pulses as drive commands, which are output to switching elements 29A to 34A. The individual PWM pulse is generated as a pulse signal indicated by two different voltage values of a high level and a low level by comparing a corresponding one of U-phase voltage command value Vu_{A}*, V-phase voltage command value Vv_{A}*, and W-phase voltage command value Vw_{A}* with the triangular wave. For example, when any one of U-phase voltage command value Vu_{A}*, V-phase voltage command value Vv_{A}*, and W-phase voltage command value Vw_{A}* is equal to or greater than the voltage value of the triangular wave, a high-level PWM pulse may be generated for this corresponding phase. When any one of U-phase voltage command value Vu_{A}*, V-phase voltage command value Vv_{A}*, and W-phase voltage command value Vw_{A}* is less than the voltage value of the triangular wave, a low-level PWM pulse may be generated for this corresponding phase. In short, for each PWM pulse, drive command generation unit 51A determines the rising timing at which this PWM pulse rises from the low level to the high level and the falling timing at which this PWM pulse falls from the high level to the low level.

Although not illustrated, complementary PWM may be used to prevent the freewheeling diodes from generating heat due to the back electromotive force of motor 2. In the complementary PWM, during switching, the ON and OFF periods of upper-arm switching elements 29A, 31A, and 33A are opposite to those of lower-arm switching elements 30A, 32A, and 34A. Specifically, in the complementary PWM, the PWM pulses that are output to upper-arm switching elements 29A, 31A, and 33A and the PWM pulses that are output to lower-arm switching elements 30A, 32A, and 34A are generated such that the levels of the former PWM pulses are opposite to those of the latter PWM pulses. However, when the PWM pulses generated by the complementary PWM are output to switching elements 29A to 34A, the ON periods of the two upper-arm and lower-arm switching elements in the same phase may instantaneously overlap with each other and cause a short circuit. Therefore, the PWM pulses generated by the complementary PWM are provided with a predetermined dead time for intentionally shifting the turning-on of the two switching elements in the same phase from the turning-off. When the complementary PWM is not used, the PWM pulses may be output to either upper-arm switching elements 29A, 31A, and 33A or lower-arm switching elements 30A, 32A, and 34A.

Controller 26A sets the time interval between two start timings of the up-counting performed by timer signal generation unit 49A as one control cycle. Thus, controller 26A starts acquiring data of steering torque T_{A}, vehicle velocity ν_{A}, rotor rotation angle θ_{A}, and three-phase actual current values Iu_{A}, Iv_{A}, and Iw_{A} in response to each up-counting start timing (and preferably, in response to each down-counting start timing as well). Next, controller 26A calculates three-phase voltage command values Vu_{A}*, Vv_{A}*, and Vw_{A}* based on the acquired data, compares three-phase voltage command values Vu_{A}*, Vv_{A}*, and Vw_{A}* with the triangular wave, and determines the rising and falling timings of the PWM pulses.

In FIG. 6, controller 26B has basically the same functions as those of controller 26A. The above description of the functions of controller 26A is applicable to the functions of controller 26B, except for part of the functions, by replacing “A” in the reference numerals of the functional blocks and the control parameters with “B”. Therefore, redundant description of the same functions of controller 26B as those of controller 26A will be omitted. The following description will be made with a focus on the difference between the functions of controllers 26A and 26B.

The control cycle of controller 26B is set to synchronize with that of controller 26A. More specifically, the up-counting start timings and the down-counting start timings by a timer signal generation unit 49B of controller 26B are set to synchronize with those by timer signal generation unit 49A. Thus, controller 26B acquires data of a steering torque T_{B}, a vehicle velocity ν_{B}, a rotor rotation angle θ_{B}, and three-phase actual current values Iu_{B}, Iv_{B}, and Iw_{B} at the same timings as the data acquisition of steering torque T_{A}, vehicle velocity ν_{A}, rotor rotation angle θ_{A}, and three-phase actual current values Iu_{A}, Iv_{A}, and Iw_{A}. Therefore, the data of steering torques T_{A} and T_{B}, the data of vehicle velocities ν_{A} and ν_{B}, the data of rotor rotation angles θ_{A} and θ_{B}, and the data of three-phase actual current values Iu_{A}, Iv_{A}, and Iw_{A} and three-phase actual current values Iu_{B}, Iv_{B}, and Iw_{B} in the respective systems are approximately equal to each other, provided that measurement errors between the systems are ignored.

Although not limited to any particular method, the synchronization between the control cycle of controller 26B and the control cycle of controller 26A can be achieved as follows. For example, a clock signal generation unit 48B generates a clock signal that is synchronized with the clock signal generated by clock signal generation unit 48A based on a synchronization signal that is output from controller 26A. Timer signal generation unit 49B synchronizes the up-counting and down-counting start timings with timer signal generation unit 49A based on the synchronization signal that is output from controller 26A, and generates a timer signal by using the clock signal that has been synchronized by clock signal generation unit 48B. A triangular wave generation unit 50B generates a triangular wave by using this timer signal. When clock signal generation units 48A and 48B use alternating-current signals of the fundamental frequency that are output from an oscillation circuit (not illustrated) shared in the first and second systems, clock signal generation unit 48B does not need to use the synchronization signal that is output from controller 26A.

Controller 26B includes a triangular wave correction unit 52B that corrects the phase of the triangular wave generated by triangular wave generation unit 50B by delaying or advancing the phase by 180°, so as to generate a reverse-phase triangular wave. When the positive potential waveform and the negative potential waveform of the triangular wave generated by triangular wave generation unit 50B are symmetric with respect to the 0 (zero) potential as the symmetry axis, triangular wave correction unit 52B may generate the reverse-phase triangular wave by reversing the polarities of the triangular wave, that is, by reversing the positive and negative voltage values of the triangular wave.

Controller 26B includes a rotor rotation angle correction unit 53B that acquires a corrected rotor rotation angle (θ_{B}±π). Specifically, rotor rotation angle correction unit 53B corrects rotor rotation angle θ_{B} by delaying or advancing rotor rotation angle θ_{B} by an electric angle of 180° in accordance with the phase inversion by triangular wave correction unit 52B such that corrected rotor rotation angle (θ_{B}±π) is used by a dq-to-three-phase conversion unit 47B.

By using the data of corrected rotor rotation angle (θ_{B}±π), dq-to-three-phase conversion unit 47B converts a d-axis voltage command value Vd_{B}* and a q-axis voltage command value Vq_{B}* into three-phase voltage command values, that is, a U-phase voltage command value Vu_{B}*, a V-phase voltage command value Vv_{B}* and a W-phase voltage command value Vw_{B}*, as expressed by Equations 2 below. Three-phase voltage command values Vu_{B}*, Vv_{B}*, and Vw_{B}* change sinusoidally as rotor rotation angle θ_{B} changes over time, and are obtained as alternating-current voltages having the same amplitude and having a phase difference of 120° from each other. Three-phase voltage command values Vu_{B}*, Vv_{B}*, and Vw_{B}* change at a frequency (θ_{B}/2π) proportional to rotor angle velocity ω>_{B} on the time axis.

$$\begin{matrix}{Vu}_{B}^{*} = k \{ {Vd}_{B}^{*} cos ( {θ}_{B} \pm π ) - {Vq}_{B}^{*} sin ( {θ}_{B} \pm π ) \} \\ {Vv}_{B}^{*} = k [ ( {Vd}_{B}^{*} cos \{ ( {θ}_{B} \pm π ) - 2 π / 3 \} - {Vq}_{B}^{*} sin \{ ( {θ}_{B} \pm π ) - 2 π / 3 \} ] \\ {Vw}_{B}^{*} = k [ {Vd}_{B}^{*} cos \{ ( {θ}_{B} \pm π ) - 4 π / 3 \} - {Vq}_{B}^{*} sin \{ ( {θ}_{B} \pm π ) - 4 π / 3 \} ] \\ where k is a constant\end{matrix} . \} \qquad ( 2 )$$

A drive command generation unit 51B generates PWM pulses as drive commands, which are output to switching elements 29B to 34B, by comparing three-phase voltage command values Vu_{B}*, Vv_{B}*, and Vw_{B}* with the reverse-phase triangular wave.

The above-described functions of controllers 26A and 26B may be partially or entirely realized by a hardware configuration, instead of by software processing.

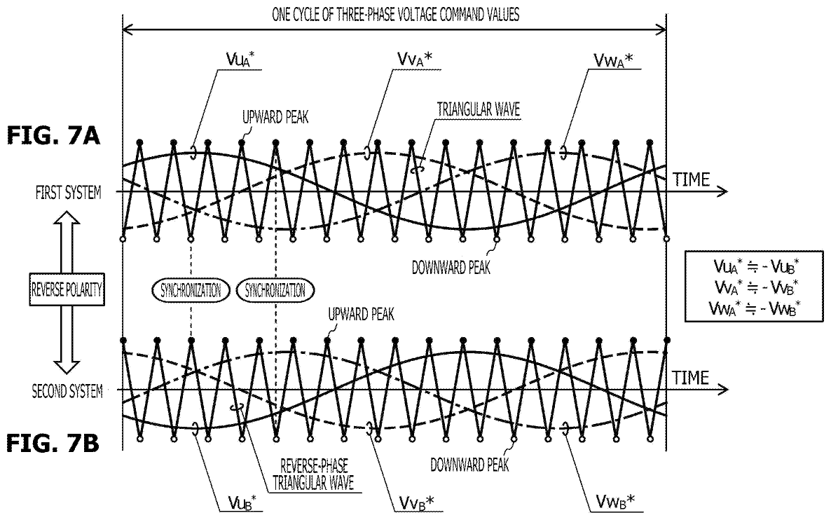

FIG. 7A schematically illustrates three-phase voltage command values Vu_{A}*, Vv_{A}*, and Vw_{A}* and the triangular wave generated by controller 26A in the first system. FIG. 7B schematically illustrates three-phase voltage command values Vu_{B}*, Vv_{B}*, and Vw_{B}* and the reverse-phase triangular wave generated by controller 26B in the second system.

As illustrates in FIG. 7A, in the triangular wave generated by triangular wave generation unit 50A, the time period between a downward peak (see white circle) at which the triangular wave reaches its minimum voltage value and the next downward peak, which appears after an upward peak (see black circle) at which the triangular wave reaches its maximum voltage value, matches one control cycle of controller 26A. The frequency of the triangular wave matches the switching frequency of switching elements 29A to 34A.

As illustrated in FIG. 7B, in the reverse-phase triangular wave generated by triangular wave correction unit 52B, the time period between an upward peak (see black circle) at which the reverse-phase triangular wave reaches its maximum voltage value and the next upward peak, which appears after a downward peak (see white circle) at which the reverse-phase triangular wave reaches its minimum voltage value, matches one control cycle of controller 26B. The frequency of the reverse-phase triangular wave matches the switching frequency of switching elements 29B to 34B.

As illustrated in FIGS. 7A and 7B, the downward peaks (see white circles in FIG. 7A) of the triangular wave generated by triangular wave generation unit 50A and the upward peaks (see black circles in FIG. 7B) of the reverse-phase triangular wave generated by triangular wave correction unit 52B are synchronized with each other. Furthermore, the upward peaks (see black circles in FIG. 7A) of the triangular wave generated by triangular wave generation unit 50A and the downward peaks (see white circles in FIG. 7B) of the reverse-phase triangular wave generated by triangular wave correction unit 52B are synchronized with each other. Thus, the triangular wave generated by triangular wave generation unit 50A and the reverse-phase triangular wave generated by triangular wave correction unit 52B have a reverse-phase relationship. In particular, when the positive potential waveform and the negative potential waveform of the triangular wave generated by triangular wave generation unit 50B are symmetric with respect to the 0 (zero) potential as the symmetry axis, the reverse-phase triangular wave has the reversed polarities with respect to those of the triangular wave generated by triangular wave generation unit 50A.

Three-phase voltage command values Vu_{A}*, Vv_{A}*, and Vw_{A}* (see FIG. 7A) obtained by conversion performed by dq-to-three-phase conversion unit 47A have a reverse-phase relationship with their respective three-phase voltage command values Vu_{B}*, Vv_{B}*, and Vw_{B}* (see FIG. 7B) obtained by conversion performed by dq-to-three-phase conversion unit 47B. In other words, three-phase voltage command values Vu_{B}*, Vv_{B}*, and Vw_{B}* obtained by the conversion performed by dq-to-three-phase conversion unit 47B match the values obtained by reversing the polarities of their respective three-phase voltage command values Vu_{A}*, Vv_{A}*, and Vw_{A}* obtained by the conversion performed by dq-to-three-phase conversion unit 47A (Vu_{A}*≈−Vu_{B}*, Vv_{A}*≈−Vv_{B}*, and Vw_{A}*≈−Vw_{B}*). This is because, since the above data is acquired at the same timing in each system as described above, the measured values or calculated values obtained in the respective systems are approximately equal to each other between rotor rotation angles θ_{A} and θ_{B}, between d-axis voltage command values Vd_{A}* and Vd_{B}*, and between q-axis voltage command values Vq_{A}* and Vq_{B}* in the above Equations 1 and 2, provided that measurement errors and the like between the systems are ignored.

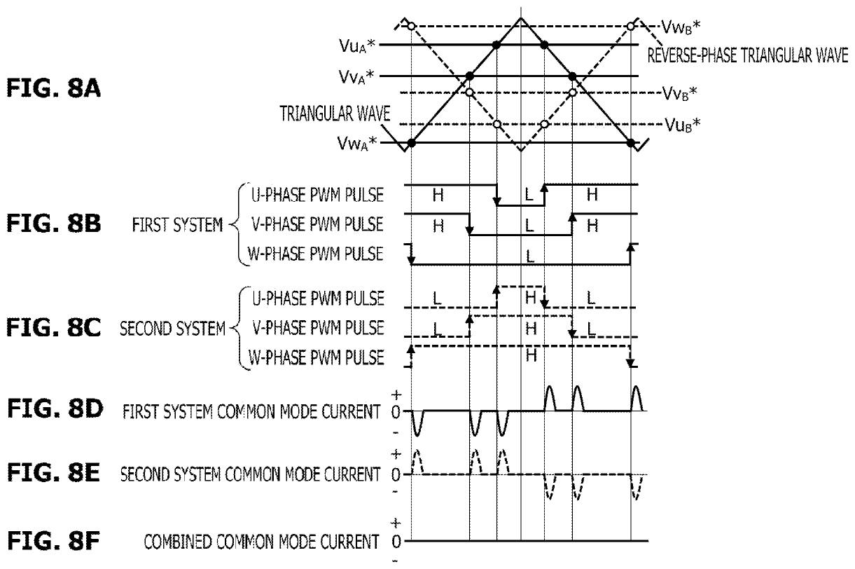

FIGS. 8A-8F illustrate an example of PWM pulses and common mode currents in the first and second systems. As illustrated in FIGS. 7A and 7B, there is a reverse-polarity relationship between the voltage values of the triangular wave and the reverse-phase triangular wave. In addition, there is a reverse-polarity relationship between three-phase voltage command values Vu_{A}*, Vv_{A}*, and Vw_{A}* generated by controller 26A and their respective three-phase voltage command values Vu_{B}*, Vv_{B}*, and Vw_{B}* generated by controller 26B. Accordingly, as illustrated in FIG. 8A, the timing at which U-phase voltage command value Vu_{A}* matches the voltage value of the triangular wave is the same as or very close to the timing at which U-phase voltage command value Vu_{B}* matches the voltage value of the reverse-phase triangular wave. Therefore, as illustrated in FIGS. 8B and 8C, the rising timing of the U-phase PWM pulse generated by drive command generation unit 51A is the same as or very close to the falling timing of the U-phase PWM pulse generated by drive command generation unit 51B. In addition, as illustrated in FIGS. 8B and 8C, the falling timing of the U-phase PWM pulse generated by drive command generation unit 51A is the same as or very close to the rising timing of the U-phase PWM pulse generated by drive command generation unit 51B. The rising and falling timings of the V-phase PWM pulse and the W-phase PWM pulse are also reversed between the first and second systems in the same way (see FIGS. 8B and 8C).

There is parasitic capacitance C1 between inverter 21A and housing 27 and between inverter 21B and housing 27, and there is parasitic capacitance C2 between motor 2 and housing 17 (see FIG. 4). As illustrated in FIGS. 8B and 8D, in the first system, when switching element 29A is turned on by the rising of the U-phase PWM pulse that is output from controller 26A, a U-phase output voltage Vu_{A} of inverter 21A significantly rises. Because the common mode current flowing between inverter 21A and housing 27 is expressed by (C1×dVu_{A}/dt), this common mode current has a positive value and leaks from inverter 21A to housing 27. In addition, because the common mode current flowing between motor 2 and housing 17 is expressed by (C2×dVu_{A}/dt), this common mode current also has a positive value and leaks from motor 2 to housing 17. In the first system, positive common mode currents leak at the rising of the V-phase and W-phase PWM pulses in the same way as described above. As a result, when upper-arm switching elements 29A, 31A, and 33A of inverter 21A are turned on by the rising of the PWM pulses that are output from controller 26A, the positive common mode currents leak from the first system.

In contrast, in the second system, the U-phase PWM pulse that is output from controller 26B falls when the U-phase PWM pulse that is output from controller 21A rises, as described above. As illustrated in FIGS. 8C and 8E, in the second system, when switching element 29B is turned off by the falling of the U-phase PWM pulse that is output from controller 26B, a U-phase output voltage Vu_{B} of inverter 21B significantly drops. Because the common mode current flowing between inverter 21B and housing 27 is expressed by (C1×dVu_{B}/dt), this common mode current has a negative value and leaks from housing 27 to inverter 21B.

In addition, because the common mode current flowing between motor 2 and housing 27 is expressed by (C2×dVu_{A}/dt) as described above, this common mode current also has a negative value and leaks from housing 17 to motor 2. In the second system, a negative common mode current leaks at the falling of the V-phase and W-phase PWM pulses in the same way as described above. As a result, when upper-arm switching elements 29B, 31B, and 33B of inverter 21B are turned off by the fall of the PWM pulses that are output from controller 26B, the negative common mode currents leak from the second system. Thus, as illustrated in FIG. 8F, because the positive common mode currents in the first system and the negative common mode currents in the second system cancel each other out, a combined common mode current in which the common mode currents in the two systems are combined has a value very close to zero, as compared with the common mode currents in the two systems.

In addition, as illustrated in FIGS. 8B and 8D, in the first system, when upper-arm switching elements 29A, 31A, and 33A are turned off by the falling of the PWM pulses that are output from controller 26A, negative common mode currents leak. In contrast, in the second system, as illustrated in FIGS. 8C and 8E, the PWM pulses that are output from controller 26B rise at the same timing as the falling of the PWM pulses that are output from controller 26A as described above. As a result, when upper-arm switching elements 29B, 31B, and 33B are turned on, positive common mode currents leak. Thus, as illustrated in FIG. 8F, because the common mode currents in the two systems cancel each other out, a combined common mode current has a value very close to zero, as compared with the common mode currents in the two systems.

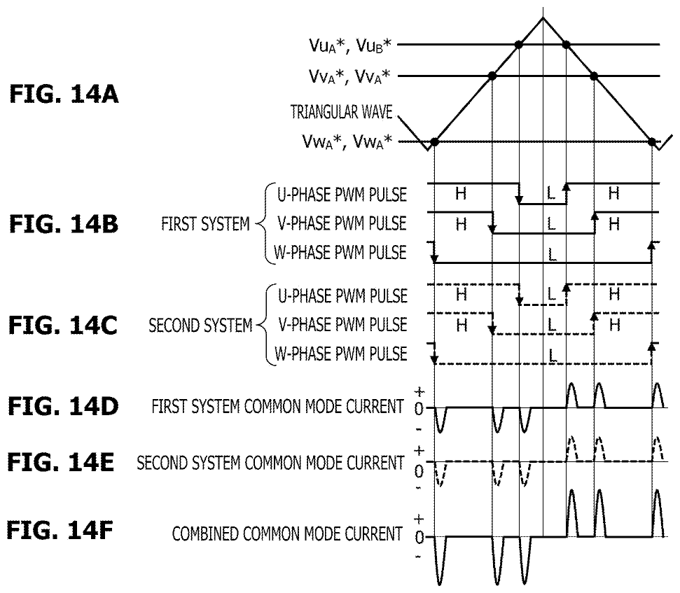

Next, common mode currents generated when controller 26B does not include triangular wave correction unit 52B and rotor rotation angle correction unit 53B will be described with reference to FIGS. 14A-14F. FIGS. 14A-14F illustrate an example of PWM pulses and common mode currents in the first and second systems in a conventional motor drive device of which controller 26B does not include triangular wave correction unit 52B and rotor rotation angle correction unit 53B.

As illustrated in FIG. 14A, when controller 26B does not include triangular wave correction unit 52B and rotor rotation angle correction unit 53B, as with controller 26A, controller 26B generates a triangular wave similar to the triangular wave illustrated in FIG. 7A and three-phase voltage command values Vu_{B}*, Vv_{B}*, and Vw_{B}* similar to the three-phase voltage command values Vu_{A}*, Vv_{A}*, and Vw_{A}* illustrated in FIG. 7A. As a result, as illustrated in FIGS. 14B and 14C, drive command generation unit 51A of controller 26A generates PWM pulses having the same waveforms as those of the PWM pulses generated by drive command generation unit 51B of controller 26B, and the rising and falling timings of these two kinds of PWM pulses match each other. Thus, as illustrated in FIGS. 14D to 14F, the positive common mode currents generated in the first and second systems are superimposed in a combined common mode current at the rising timings of the PWM pulses, and the negative common mode currents generated in the first and second systems are superimposed in the combined common mode current at the falling timings of the PWM pulses. The positive common mode currents leak to housings 27 and 17 and return to the power supply lines connecting the positive electrode and the negative electrode of in-vehicle battery 4 with motor drive device 3 in the same phase via the vehicle body and parasitic capacitance C3 between in-vehicle battery 4 and housing 28. The negative common mode currents flow in the direction opposite to that of the positive common mode currents. These common mode currents significantly affect, as radiation noise, the operations of peripheral electrical components. Therefore, to reduce these common mode currents, the conventional motor drive device needs to be provided with an electric component for noise suppression such as a Y capacitor or a choke coil in each system.

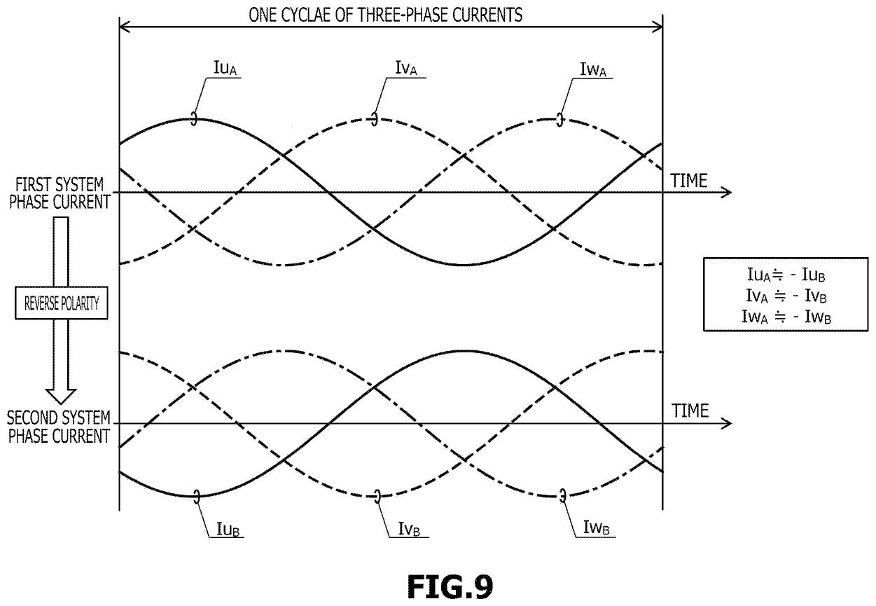

FIG. 9 illustrates an example of three-phase currents in the first system and the second system. As described above, the rising and falling timings of the PWM pulses are reversed between the systems. Thus, three-phase actual current values Iu_{A}, Iv_{A}, and Iw_{A} of winding set 13A in the first system and three-phase actual current values Iu_{B}, Iv_{B}, and Iw_{B} of winding set 13B in the second system change while maintaining a reverse-phase or reverse-polarity relationship (Iu_{A}≈−Iu_{B}, Iv_{A}≈−Iv_{B}, and Iw_{A}≈−Iw_{B}). If the winding direction of coils 14A to 16A of winding set 13A is the same as the winding direction of coils 14B to 16B of winding set 13B, each pair of coils of the same phase, that is, U-phase coils 13A and 13B, V-phase coils 14A and 14B, and W-phase coils 15A and 15B, generate opposite directions of magnetic fluxes. As a result, motor 2 cannot be rotated smoothly. However, as illustrated in FIG. 3, in motor 2, the winding direction of winding set 13A is different from that of winding set 13B, and therefore, similar magnetic fluxes are generated in the same direction in the same-phase coils of winding set 13A and winding set 13B. As a result, rotating magnetic fields in the same direction in electric angle are generated around winding sets 13A and 13B. Thus, although three-phase actual current values Iu_{A}, Iv_{A}, and Iw_{A} of winding set 13A and three-phase actual current values Iu_{B}, Iv_{B}, and Iw_{B} of winding set 13B have a reverse-phase or reverse-polarity relationship, motor 2 can be smoothly rotated.

As described above, motor drive device 3 rotates motor 2 by performing its energization control operation such that the rising of the PWM pulses that are output from controller 26A to inverter 21A and the falling of the PWM pulses that are output from controller 26B to inverter 21B match each other. In addition, motor drive device 3 rotates motor 2 by performing its energization control operation such that the falling of the PWM pulses that are output from controller 26A to inverter 21A and the rising of the PWM pulses that are output from controller 26B to inverter 21B match each other. In this way, the common mode currents generated in the first and second systems cancel each other out, whereby the combined common mode current is reduced. Thus, motor drive device 3 can reduce electric components for noise suppression such as a Y capacitor or a choke coil in its systems while maintaining anti-noise performance. As a result, the size reduction of the motor derive device 3 and the size reduction of the electric power steering system 1 to which motor drive device 3 is applied can be achieved.

### First Variation of Motor

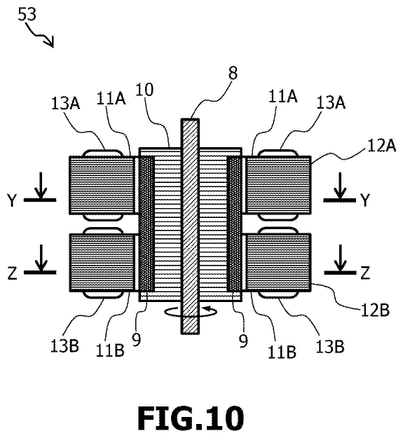

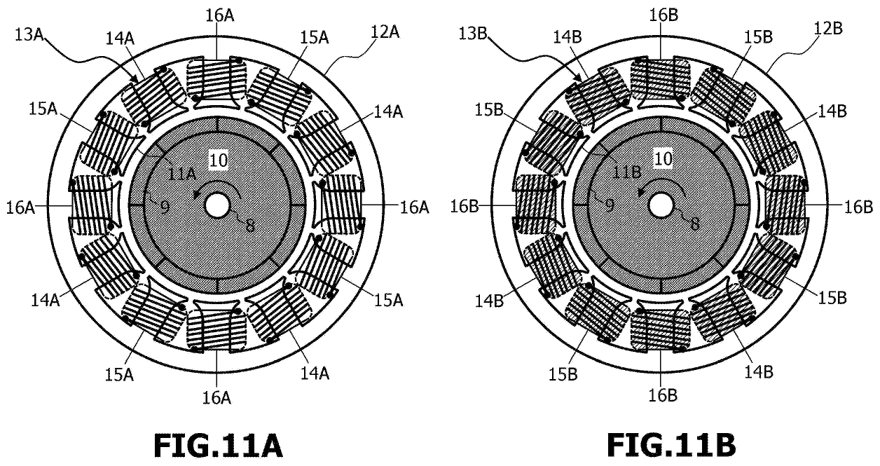

The first variation of motor 2 will be described with reference to FIGS. 10, 11A and 11B. FIG. 10 schematically illustrates a structure according to the first variation of motor 2. The same components as those of the above-described example are denoted by the same reference symbols, and description thereof will hereinafter be omitted or simplified.

A motor 53 according to the present variation differs from motor 2 in that stator 12 in motor 2 is divided into a stator 12A and a stator 12B in the axial direction of rotating shaft 8. In motor 53, only winding set 13A is disposed on stator 12A, and only winding set 13B is disposed on stator 12B.

FIG. 11A and FIG. 11B illustrate arrangement of the winding sets of motor 53. Stator 12A and stator 12B are fixedly disposed such that the locations of teeth 11A of stator 12A and the locations of teeth 11B of stator 12B match with each other in the rotation direction of rotor 10. As illustrated in FIG. 11A, three-phase coils 14A, 15A, and 16A of winding set 13A are sequentially disposed in this order around teeth 11A of stator 12A in the rotation direction of rotor 10 and wound by salient-pole concentrated winding. As illustrated in FIG. 11B, three-phase coils 14B, 15B, and 16B of winding set 13B are disposed around teeth 11B of stator 12B such that the locations of these coils correspond to those of three-phase coils 14A, 15A, and 16A wound around teeth 11A in the rotation direction of rotor 10. In addition, three-phase coils 14B, 15B, and 16B are wound by salient-pole concentrated winding. However, the winding direction of three-phase coils 14A, 15A, and 16A of winding set 13A is different from that of three-phase coils 14B, 15B, and 16B of winding set 14B.

In the arrangement of the winding sets in FIG. 11A and FIG. 11B, too, since each pair of coils of the same phase in winding set 13A and winding set 13B generate similar magnetic fluxes in the same direction, rotating magnetic fields in the same direction in electric angle are generated around winding sets 13A and 13B. Thus, although three-phase actual current values Iu_{A}, Iv_{A}, and Iw_{A} of winding set 13A and three-phase actual current values Iu_{B}, Iv_{B}, and Iw_{B} of winding set 13B have a reverse-phase or reverse-polarity relationship, motor 53 can be smoothly rotated.

### Second Variation of Motor

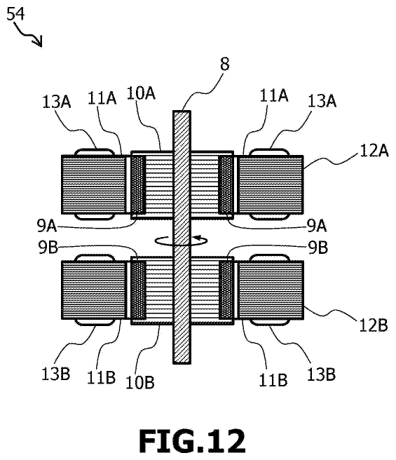

The second variation of motor 2 will be described with reference to FIG. 12. FIG. 12 schematically illustrates a structure according to the second variation of motor 2.

A motor 54 according to the present variation differs from motor 2 in that rotor 10 in motor 2 is divided into a rotor 10A and a rotor 10B in the axial direction of rotating shaft 8, and rotor 10A and rotor 10B are coupled to each other in the rotation shaft direction (coupled by rotating shaft 8, for example). In addition, motor 54 differs from motor 2 in that stator 12 in motor 2 is divided into a stator 12A and a stator 12B in the axial direction of rotating shaft 8, teeth 11A of stator 12A are fixedly disposed so as to face permanent magnets 9A of rotor 10A, and teeth 11B of stator 12B are fixedly disposed so as to face permanent magnets 9B of rotor 10B. Furthermore, motor 54 differs from motor 2 in that only winding set 13A is disposed on stator 12A and that only winding set 13B is disposed on stator 12B.

In motor 54 having the structure in FIG. 12, three-phase coils 14A, 15A, and 16A of winding set 13A are sequentially disposed in this order around teeth 11A in the rotation direction of rotor 10A and wound by salient-pole concentrated winding. In addition, in motor 54, three-phase coils 14B, 15B, and 16B of winding set 13B are sequentially disposed in this order around teeth 11B in the rotation direction of rotor 10B and wound by salient-pole concentrated winding. In motor 54, regarding permanent magnets 9A of rotor 10A and permanent magnets 9B of rotor 10B, their locations in the rotation direction can be determined separately. The relative locations of permanent magnets 9A of rotor 10A and permanent magnets 9B of rotor 10B in the rotation direction may be determined such that the rotating magnetic fields of stators 12A and 12B rotate in the same direction. Thus, the locations of three-phase coils 14A, 15A, and 16A of winding set 13A do not need to match the locations of three-phase coils 14B, 15B, and 16B of winding set 13B in the rotation direction. Additionally or alternatively, the winding direction of three-phase coils 14A, 15A, and 16A of winding set 13A may be the same as the winding direction of three-phase coils 14B, 15B, and 16B of winding set 13B. Even in these cases, by adjusting the locations of permanent magnets 9A of rotor 10A in the rotation direction and the locations of permanent magnets 9B of rotor 10B in the rotation direction, the rotating magnetic fields of stators 12A and 12B can be rotated in the same direction. For example, in a case in which three-phase coils 14A, 15A, and 16A of winding set 13A and three-phase coils 14B, 15B, and 16B of winding set 13B are disposed at the matching locations in the rotation direction and in which the winding direction of the coils of winding set 13A is set to be the same as that of the coils of winding set 13B, the following adjustment can be performed. That is, the locations of permanent magnets 9B of rotor 10B in the rotation direction may be shifted by an electric angle of 180° with respect to the locations of permanent magnets 9A of rotor 10A in the rotation direction.

### Third Variation of Motor

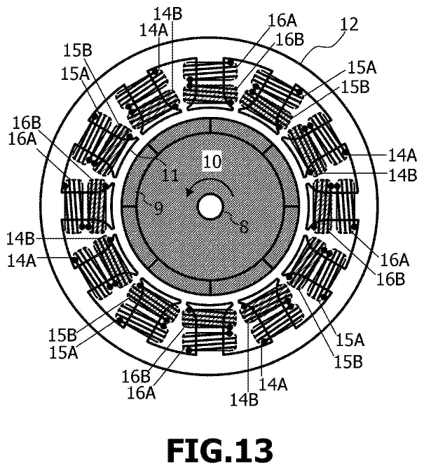

The third variation of motor 2 will be described with reference to FIG. 13. FIG. 13 illustrates arrangement of the winding sets according to the third variation of motor 2. Three-phase coils 14A, 15A, and 16A of winding set 13A are sequentially disposed in this order around all the individual teeth 11 of stator 12 in the rotation direction of rotor 10 and are wound by salient-pole concentrated winding. In addition, three-phase coils 14B, 15B, and 16B of winding set 13B are sequentially wound around all the individual teeth 11 of stator 12 by salient-pole concentrated winding so that a pair of coils of the same phase, that is, U-phase coils 13A and 13B, V-phase coils 14A and 14B, or W-phase coils 15A and 15B are formed in each of teeth 11. However, the winding direction of three-phase coils 14A, 15A, and 16A of winding set 13A is different from that of three-phase coils 14B, 15B, and 16B of winding set 14B.

In the arrangement of the winding sets in FIG. 13, too, because each pair of coils of the same phase in winding set 13A and winding set 13B generate similar magnetic fluxes in the same direction, rotating magnetic fields in the same direction in electric angle are generated around winding sets 13A and 13B. Thus, although three-phase actual current values Iu_{A}, Iv_{A}, and Iw_{A} of winding set 13A and three-phase actual current values Iu_{B}, Iv_{B}, and Iw_{B} of winding set 13B have a reverse-phase or reverse-polarity relationship, motor 2 can be smoothly rotated.

Although the present invention has thus been described in detail with reference to suitable examples, it is apparent to those skilled in the art that various modifications can be made as follows based on the basic technical concepts and teachings of the present invention.

For example, dq-to-three-phase conversion unit 47B of controller 26B may acquire three-phase voltage command values Vu_{B}*, Vv_{B}*, and Vw_{B}* without using corrected rotor rotation angle (θ_{B}±π). In this case, dq-to-three-phase conversion unit 47B simply converts voltage command values Vd_{B}* and Vq_{B}* by using rotor rotation angle θ_{B} and reverses the polarities of the obtained values, to acquire three-phase voltage command values Vu_{B}*, Vv_{B}*, and Vw_{B}*.

In electric power steering system 1, motor drive device 3 may be constructed to include a single controller shared by both of the systems, instead of including redundant controllers 26A and 26B. In this case, the shared controller performs its energization control operation on winding sets 13A and 13B. The shared controller generates a shared clock signal and a triangular wave shared by both of the systems based on this clock signal. Thus, the synchronization between controllers 26A and 26B is unnecessary, and the processing load needed for controlling the energization is reduced.

When controller 26A and 26B use complementary PWM, the PWM pulses that are output to upper-arm switching elements 29B, 31B, and 33B by controller 26B may be generated based on the PWM pulses (before dead time compensation) that are output to lower-arm switching elements 30A, 32A, and 34A by controller 26A. Similarly, the PWM pulses that are output to lower-arm switching elements 30B, 32B, and 34B by controller 26B may be generated based on the PWM pulses (before dead time compensation) that are output to upper-arm switching elements 29A, 31A, and 33A by controller 26A. In this way, the rising of the PWM pulses in the first system can be synchronized with the falling of the PWM pulses in the second system, and the falling of the PWM pulses in the first system can be synchronized with the rising of the PWM pulses in the second system, without performing the complex processing by controller 26B. This PWM pulse generation method can be used until an abnormality occurs in the first system and the output of inverter 21A is stopped. In particular, when a single controller shared by both of the systems is provided, this method can be regarded as one of practical PWM pulse generation methods.

When an abnormality occurs in the first system and the output of inverter 21A is stopped, controller 26B may independently generate a clock signal, and consequently, a triangular wave, whether or not controller 26A outputs a synchronization signal. To reduce the processing load, controller 26B may stop the functions of triangular wave correction unit 52B and rotor rotation angle correction unit 53B. In this case, drive command generation unit 51B generates PWM pulses by comparing three-phase voltage command values Vu_{B}*, Vv_{B}*, and Vw_{B}*, which dq-to-three-phase conversion unit 47B has obtained by converting d-axis voltage command value Vd_{B}* and q-axis voltage command value Vq_{B}* by using rotor rotation angle θ_{B} by, with the triangular wave, which triangular wave generation unit 50B has generated.

In electric power steering system 1, a single measuring device shared by both of the systems may be used as rotation angle sensors 23A and 23B, and the same applies to torque sensors 5A and 5B and vehicle velocity sensors 7A and 7B. In addition, in electric power steering system 1 described above, in-vehicle battery 4 may be redundantly provided as a first in-vehicle battery and a second in-vehicle battery so as to improve the reliability of the system. In this case, the first in-vehicle battery may supply electric power to inverter 21A, and the second in-vehicle battery may supply electric power to inverter 21B.

Electrical connection between at least one of housings 17, 27, and 28 and a reference ground such as a vehicle body may be omitted. Even in this case, a common mode current can flow between housings 17, 27, and 28 and the reference ground. Thus, it is useful to apply motor drive device 3 to electric power steering system 1.

In motors 2, 53, and 54, winding set 13A and winding set 13B may be wound on stators 12, 12A, and 12B by distributed winding, instead of salient-pole concentrated winding. In particular, in motor 2 and 53, like rotating magnetic fields can be generated if the winding directions of winding sets 13A and 13B wound by distributed winding are different from each other.

Motor 2 and motor drive device 3 may be stored in a shared housing, instead of being stored in their respective housings 17 and 27. In addition, instead of the triangular waves, sawtooth waves may be used as the carrier signals.

Motor drive device 3 described above is applicable to electric power steering system 1 that does not serve as a power steering system but serves as an autonomous steering device that autonomously performs steering for autonomous driving or semi-autonomous driving of vehicle 1000. In the above examples, although motor drive device 3 is applied to electric power steering system 1, motor drive device 3 is also applicable to any in-vehicle system including two redundant motor energization systems.

The individual technical concepts and variations based on these concepts described in the above example can be appropriately combined and used, as long as there is no conflict.

### REFERENCE SYMBOL LIST

2, 53, 54 motor
3 motor drive device
10, 10A, 10B rotor
12, 12A, 12B stator
13A winding set (first system)
13B winding set (second system)
14A U-phase coil (first system)
14B U-phase coil (second system)
15A V-phase coil (first system)
15B V-phase coil (second system)
16A W-phase coil (first system)
16B W-phase coil (second system)
21A inverter (first system)
21B inverter (second system)
26A controller (first system)
26B controller (second system)

1. A motor drive device which drives a motor including a first winding set and a second winding set that are electrically separate from each other, the motor drive device comprising:
a first inverter that outputs three-phase alternating currents to the first winding set;
a second inverter that outputs three-phase alternating currents to the second winding set; and
a controller that outputs drive commands to the first inverter and the second inverter by generating PWM pulses,
wherein the controller generates the PWM pulses such that the three-phase alternating currents that are output from the first inverter to the first winding set and the three-phase alternating currents that are output from the second inverter to the second winding set have reverse polarities in three respective phases.

2. The motor drive device according to claim 1, wherein levels of the PWM pulses that are output to the first inverter and levels of the PWM pulses that are output to the second inverter have an inverse relationship in three respective phases.

3. The motor drive device according to claim 1,
wherein the PWM pulses that are output to the first inverter are generated based on a comparison between first three-phase voltage command values and a first triangular wave, and the PWM pulses that are output to the second invert are generated based on a comparison between second three-phase voltage command values obtained by inverting the first three-phase voltage command values and a second triangular wave obtained by inverting the first triangular wave.

4. The motor drive device according to claim 1,
wherein the motor includes a rotor and a stator on which the first winding set and the second winding set are disposed, and
wherein the first winding set and the second winding set are wound on the stator such that rotating magnetic fields generated by the first winding set and the second winding set are in an identical direction.

5. The motor drive device according to claim 4, wherein a winding direction of three-phase coils of the first winding set is opposite to a winding direction of three-phase coils of the second winding set.

6. The motor drive device according to claim 5, wherein the three-phase coils of the first winding set are wound around half of teeth of the stator, and the three-phase coils of the second winding set are wound around the remaining half of the teeth of the stator.

7. The motor drive device according to claim 5, wherein a coil of the first winding set and a coil of the second winding set, the coils being in an identical phase, are wound together around an individual one of the teeth of the stator.

8. The motor drive device according to claim 1,
wherein the motor includes a rotor, a first stator on which the first winding set is disposed, and a second stator on which the second winding set is disposed, and
wherein three-phase coils of the first winding set are wound on the first stator and three-phase coils of the second winding set are wound on the second stator such that a rotating magnetic field generated by the first rotor and a rotating magnetic field generated by the second rotor are in an identical direction.

9. The motor drive device according to claim 8, wherein a winding direction of the three-phase coils of the first winding set is opposite to a winding direction of the three-phase coils of the second winding set.

10. The motor drive device according to claim 1,
wherein the motor includes a first stator on which the first winding set is disposed, a second stator on which the second winding set is disposed, a first rotor paired with the first stator, and a second rotor paired with the second stator, and
wherein the first rotor and the second rotor are coupled to each other in a rotation shaft direction.

11. The motor drive device according to claim 10, wherein relative locations of permanent magnets of the first rotor and permanent magnets of the second rotor in a rotation direction are determined such that a rotating magnetic field generated by the first stator and a rotating magnetic field generated by the second stator rotate in an identical direction.
